(19) United States
(12) Patent Application Publication
(10) Pub. No.: US 2003/0102616 A1
(43) Pub. Date: Jun. 5, 2003

(54) Conveying unit for flat objects

(76) Inventor: Berthold Peter Held, Heuchelheim (DE)

Correspondence Address: Douglas R Hanscom, Jones Tullar & Cooper, Eads Station, PO Box 2266, Arlington, VA, 22202, US

(21) Appl. No.: 10/311,303

(22) PCT Filed: Dec. 14, 2001
(86) PCT No.: PCT/DE01/04717

(30) Foreign Application Priority Data
Mar. 6, 2001 (DE) 10111361.7

(51) Int. Cl. B42C 1/00

(52) U.S. Cl. 270/47

(57) ABSTRACT

A conveying unit that is useable for the conveyance of generally flat objects, particularly in a folder of a rotary printing press, includes endless first and second belts and a roller. A conveying path for the flat objects extends initially between the two belts and then subsequently between the second belt and the surface of the roller. The second belt is driven by a drive device at a speed which can be regulated independently of the rotational speed of the roller.

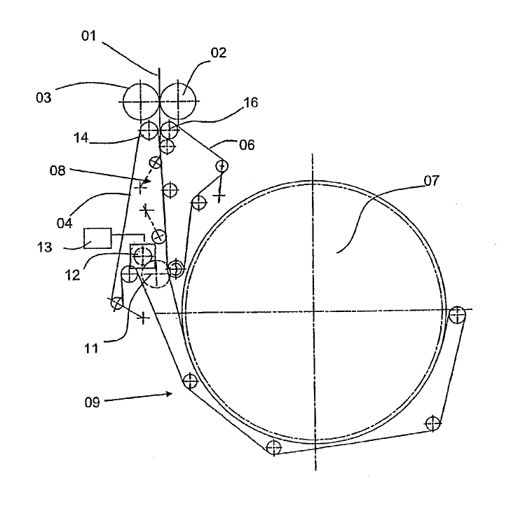

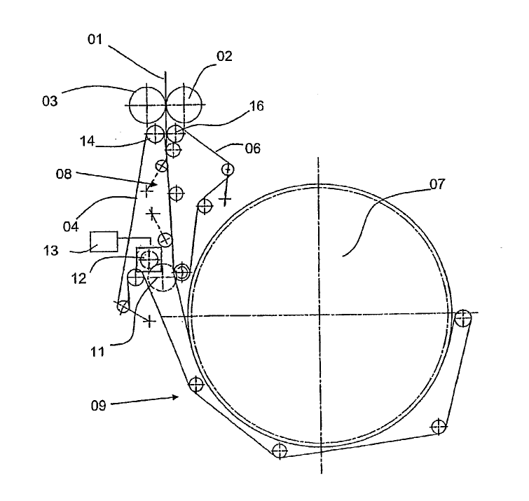

The invention relates to a conveying unit for conveying flat objects in accordance with the preamble of claim 1.

For example, such conveying units are employed in folding apparatus for conveying signatures which had previously been cut off a web of imprinted material.

The signatures consist of a variable number of sheets which are not connected with each other. In the course of conveying the signatures it is therefore of great importance that the two endless belts and the roller move at speeds which are exactly matched to each other in order to prevent shearing forces from acting on the signatures clamped between them, which might lead to deformation and fanning of the signatures in the course of their conveyance.

In conventional conveying units of the type mentioned above, the movement of the second endless belt is coupled via a transmission gear with a fixed transmission ratio to the rotation of the roller. The first endless belt, which partially loops around the roller, is driven by the roller by friction. Therefore the path speed of the first belt corresponds to the circumferential speed of the roller if no objects are conveyed between them. If conveyed objects are located in the loop area between the roller and the first belt, this has an effect on the speed of the first belt which is similar to an increase of the diameter of the roller. The speed of the first belt therefore increases with the thickness of the objects to be conveyed. The speed of the second belt is constant. This has the result that only with a definite thickness of the objects to be conveyed do the two belts run exactly the same, so that the objects are not subjected to shearing forces.

DE 42 41 810 A1 discloses a folding apparatus wherein first and second belts are arranged between the cutting cylinder and the folding cylinder. These belts are driven together by a common motor.

The object of the invention is based on providing a conveying unit for flat objects.

In accordance with the invention, this object is attained by means of the characteristics of claim 1.

The advantages which can be attained by means of the invention rest in particular in that it is always possible to produce the same speed between the two endless belts, even with differences in the thickness of the objects to be conveyed, so that the objects can be conveyed gently and free of shearing.

It is provided for this purpose that the conveying unit has a drive mechanism for the second belt which can be regulated independently of the speed of rotation of the roller.

This drive mechanism is usefully assigned to a regulating device acting to match the speeds of the two belts. This regulating device preferably regulates the speed of the second belt proportionally to the speed of rotation of the roller by means of a variable proportionality factor. By matching the proportionality factor as a function of the thickness of the objects to be conveyed, it is possible to achieve that objects of variable thickness are conveyed free of shearing.

To determine the proportionality factor, the regulating device can be connected to a sensor for measuring the speed of the first belt. The speed of the latter varies linearly with the thickness of the conveyed objects; freedom from shear can be achieved by means of a simple matching of the speed of the two belts.

It is also conceivable to couple the regulating device to a sensor for detecting the shearing deformation of the conveyed objects. For example, such a sensor can be implemented by a camera with a connected electronic image processor. But it is also possible for an operator to manually vary the proportionality factor on the basis of a detected shear deformation of the conveyed objects.

Another option is to couple a sensor for detecting the thickness of the objects to the regulating device. Such a sensor can be arranged in particular upstream of the input of the regulating device in order to be able to match the belt speeds of the conveying unit to a change in thickness before the object on which the thickness measurement had been performed reaches the conveying device.

An exemplary embodiment is represented in the drawings and will be described in greater detail in what follows.

The drawings show a schematic section through a conveying unit in accordance with the invention.

The conveying unit is arranged following a cutting unit constituted by a cutter cylinder 02 and an oppositely located groove cylinder 03, by means of which a web of material 01, for example a paper web 01, which had been cut into strands in a superstructure, not represented and located above the cutting unit, with the aid of several rotating longitudinal cutters and placed one on top of the other, is cut into individual signatures. Therefore the signatures consist of a varying number of paper sheets placed on top of each other, which are not maintained fixedly attached to each other and are therefore open on all four sides.

The path along which the signatures are conveyed by the conveying unit can be divided into two sections, a first section 08, in which the signatures are conveyed, pressed between a first endless belt 04 and a second endless belt 06, and a second section 09, in which they are conveyed between the first endless belt 04 and a roller 07, for example a collecting cylinder 07 and/or a folding blade cylinder of a folding apparatus of a rotary printing press.

The collecting cylinder 07 is driven by a motor, not represented in the drawings. The first endless belt 04, which in the second section 09 loops around the collecting cylinder 07 over an angular range of at least 90°, preferably approximately 180°, is driven by the collecting cylinder 07 by friction. If signatures are conveyed in the second section 09, they transfer the driving force from the collecting cylinder 07 to the first endless belt 04. In this case the outsides of the signatures facing away from the collecting cylinder 07 have a slightly higher path speed than the shell surface of the collecting cylinder 07 itself because of their greater distance from the center of rotation of the collecting cylinder 07, wherein the speed difference is proportional to the thickness of the signatures. Therefore, with a change in the thickness of the signatures, the speed of the first endless belt 04 is automatically matched.

The second endless belt 06 is driven by a frequency-regulated motor 12 via an intermediate wheel 11. The speed of the motor is regulated by a regulating device 13 whose object it is to keep the path speeds of the two endless belts 04 and 06 identical to each other and to prevent in this way that the sheets of the signatures are displaced in respect to each other during the passage through the first section 08 and the signatures become unsightly or unusable in this way.

For this purpose, in a first embodiment of the invention the regulating device 13 is connected with two speed sensors for the path speed of the first and the second endless belt 04 and 06 and acts toward a match of these path speeds. The speed sensors can be angle of rotation sensors, which are respectively arranged on a deflection roller 14 or 16 of the first or second endless belt 04, 06 and send a pulse to the regulating device every time the deflection roller 04, 06 has traveled over a fixed angle of rotation. These angle of rotation sensors are preferably identically constructed and mounted on deflection rollers 14, 16 of identical radius. In this case the regulating device 13 can assure an identical path speed of the endless belts 04, 06 in that it maintains a constant, preferably vanishing phase offset between the pulses delivered by the two sensors. Then the speed of the second endless belt 06 is proportional to the speed of the collecting cylinder 07, wherein the proportionality factor is determined by the thickness of the signatures conveyed between the collecting cylinder 07 and the first endless belt 04.

Another possibility for regulating the speed of the second endless belt is to connect the regulating device 13 on the one hand with a sensor for the speed of the first endless belt 04 or the rotational speed of the collecting cylinder 07 and, on the other hand, with a sensor for the thickness of the signatures to be conveyed, wherein then the regulating device 13 calculates a speed to be maintained by the motor 12 from the measured speed, corrected by a proportionality factor which is a function of the measured thickness. A sensor for the thickness of the signatures, or a value proportional thereto, can be arranged at any arbitrary location in the conveying unit itself or, better yet, upstream of the start of the conveying unit at the web of material 01.

It is also conceivable that an operator sets a known thickness of the signatures, the number of their sheets and the basis weight, or any arbitrary equivalent combination of parameters at the regulator of the regulating device 13.

An operator can also make later corrections by means of such a regulator when he detects that the signatures conveyed by the conveying unit are sheared.

In accordance with a variant, not represented, a camera with an image processing unit is provided at the outlet of the conveying unit, which monitors the conveyed signatures for the occurrence of shearing. If shearing has been detected, the regulating device 13 varies the proportionality factor, which was determined by it, between the speed of rotation of the collecting cylinder 07 and the speed of the second endless belt 06 until the shearing disappears or is reduced to an acceptable value.

List of Reference Numerals

01 Web of material, paper web

02 Cutter cylinder

03 Groove cylinder

04 Endless belt, first

05 -

06 Endless belt, second

07 Collecting cylinder

08 Section, first

09 Section, second

10 -

11 Intermediate wheel

12 Motor

13 Regulating device

14 Deflection roller

15 -

16 Deflection roller

1. A conveying unit for conveying flat objects, having a first and a second endless belt (04, 06) and a roller (07), wherein a conveying path extends between the first endless belt (04) on the one hand and, on the other hand, a portion of the circumference of the roller (07) and the second endless belt (06), characterized in that the first endless belt (04) and the second endless belt (06) can be driven independently of one another.

2. The conveying unit in accordance with claim 1, characterized in that a drive arrangement (12), which can be regulated independently of the speed of rotation of the roller (07), is arranged for the second endless belt (06).

3. The conveying unit in accordance with claim 1, characterized in that a regulating device (13) is arranged for the drive arrangement (12), and acts toward a matching of the speeds of the two endless belts (04, 06).

4. The conveying unit in accordance with claim 3, characterized in that, by means of a variable proportionality factor, the regulating device (13) regulates the speed of the second endless belt (06) proportionally in respect to the speed of rotation of the roller (07).

5. The conveying unit in accordance with claim 3 or 4, characterized in that the regulating device (13) is coupled to a sensor for measuring the speed of the first endless belt (04).

6. The conveying unit in accordance with claim 3 or 4, characterized in that the regulating device (13) is coupled to a sensor for measuring a shearing deformation of the conveyed objects.

7. The conveying unit in accordance with claim 3 or 4, characterized in that the regulating device (13) is coupled to a sensor for measuring a thickness of the conveyed objects.

8. The conveying unit in accordance with claim 7, characterized in that the sensor is arranged upstream of the conveying path in the conveying direction.

9. The conveying unit in accordance with one of the preceding claims, characterized in that the first endless belt (04) is coupled to the drive mechanism of the roller (07).

10. The conveying unit in accordance with claim 9, characterized in that the first endless belt (04) is driven by frictional contact with the roller (07).

11. The conveying unit in accordance with one of the preceding claims, characterized in that the drive arrangement (12) is comprised by a frequency-regulated motor.

12. The conveying unit in accordance with one of the preceding claims, characterized in that it is arranged in a folding apparatus of a cutting unit (02, 03).

13. The conveying unit in accordance with claim 1, characterized in that the roller (07) is embodied as a cylinder (07) of a folding apparatus.

14. The conveying unit in accordance with claim 13, characterized in that the cylinder (07) is embodied as a collecting cylinder (07).

15. The conveying unit in accordance with claim 13, characterized in that the first endless belt (04) loops around the cylinder (07) by at least 90°.
